(19) United States
(12) Patent Application Publication
(10) Pub. No.: US 2011/0102121 A1
(43) Pub. Date: May 5, 2011

(54) SHEET TRANSFORMER FOR DC/DC CONVERTER

(76) Inventors: Yasunori Otsuka, Tokyo (JP); Takashi Osawa, Tokyo (JP); Fumihiro Minami, Tokyo (JP)

(21) Appl. No.: 13/000,756

(22) PCT Filed: Jul. 2, 2009
(86) PCT No.: PCT/JP2009/003074

§ 371 Date: Dec. 22, 2010

(30) Foreign Application Priority Data
Sep. 5, 2008 (JP) 2008 228566

(51) Int. Cl. H01F 27/29; H01F 5/00

(52) U.S. Cl. 336/192; 336/200

(57) ABSTRACT

A sheet transformer includes a first core having central and lateral legs penetrating a coil on a circuit board, a plate-shaped second core positioned on an end of the first core, the cores being assembled into an integral piece and an air gap being formed between the central leg and the second core, and a fixing member for fixing the cores with respect to the coil. The fixing member has holder portions having claw portions for holding the lateral legs of the first core from a side of the second core respectively, a first spring portion extending from a side of the second core toward the circuit board, for bringing inner plane portions of the legs of the first core into contact with the coil, and a second spring portion for pressing positions of the second core which are opposite to the lateral legs.

### FIELD OF THE INVENTION

The present invention relates to a sheet transformer for DC/DC converter that uses, as a coil, conducting foils (copper foils) formed in a printed circuit board.

### BACKGROUND OF THE INVENTION

Many units use a sheet transformer as a transformer which constructs a DC/DC converter for the reason that the outside shape including the core should be a thin one and a sheet transformer easily constructs an efficient DC/DC converter. For example, a sheet transformer is disclosed by patent references 1, 2, and 3.

Patent reference 1 discloses a sheet transformer in which a coil is formed in a multilayer board and is sandwiched by cores. Patent reference 2 discloses a sheet transformer which is constructed by using a coil formed in a board put on top of a board on which electronic parts are mounted. Patent reference 3 discloses a sheet transformer in which while two divided cores are assembled and fixed to each other by using a member for combining the cores to form a coil, the core is fixed to a board.

### RELATED ART DOCUMENT

### Patent reference

Patent reference 1: JP,06-215962,A
Patent reference 2: JP,08-236365,A
Patent reference 3: JP,2003-324016,A

### SUMMARY OF THE INVENTION

However, in any of above-mentioned patent references, no reference is made about a positional relationship between the coil and the cores, and the characteristic of the transformer is not taken into consideration. In particular, in patent reference 3, a challenge of fixing the cores at a specific position of the board is provided in order to acquire good characteristics, though no specific position of the cores with respect to the board is pointed out explicitly to provide good characteristics.

The present invention is made in view of such a technological situation, and it is therefore an object of the present invention to provide a sheet transformer in which a positional relationship between a coil and cores, a gap (gap) and so on therein are specified to sufficiently exhibit its characteristics.

In accordance with a first aspect of the present invention, there is provided a sheet transformer including a coil formed like a plane on a board for electronic parts on which electronic parts are mounted, a first core provided with a plurality of legs on a flat portion thereof, the plurality of legs including legs penetrating the above-mentioned coil, and a plate-shaped second core positioned on ends of legs of the above-mentioned first core, a gap being formed in a part of a core member which is a combination of the above-mentioned first core and the above-mentioned second core, wherein an inner plane portion of the above-mentioned first core is in contact with the above-mentioned planar coil, and the above-mentioned first and second cores are fixed and held with respect to the above-mentioned coil in such a way that the above-mentioned gap and the above-mentioned coil are not positioned in one plane.

In accordance with a second aspect of the present invention, there is provided a sheet transformer including a coil formed like a plane on a board for electronic parts, a first core provided with a plurality of legs on a flat portion thereof, and a gap formation portion on a central one of the above-mentioned plurality of legs penetrating the above-mentioned coil, a plate-shaped second core positioned on ends of legs of the above-mentioned first core, the above-mentioned first core and the above-mentioned second core being assembled into an integral piece and a gap being formed between the above-mentioned central leg and the above-mentioned second core, and a fixing member for fixing the above-mentioned first and second cores with respect to the above-mentioned coil, wherein the above-mentioned fixing member includes: holder portions having claw portions for holding lateral legs of the above-mentioned first core from a side of the above-mentioned second core respectively; a first spring portion for pressing positions of the above-mentioned second core which are opposite to the lateral legs of the above-mentioned first core; a second spring portion extending from a side of the above-mentioned second core toward the above-mentioned board for electronic parts, for bringing inner plane portions of the above-mentioned legs of the above-mentioned first core into contact with the above-mentioned coil; and a positioning portion for fixing the above-mentioned second core at an arbitrary position with respect to the above-mentioned first core.

In the first and second aspects of the present invention, the board on which the coil to which the above-mentioned first and second cores are assembled is formed can be a separate member. More specifically, a board for coil is disposed separately from the board for electronic parts on which electronic parts are mounted, and the coil is formed in a planar shape on this board for coil and the first core and the second core are assembled to the coil.

In accordance with a third aspect of the present invention, there is provided a sheet transformer including: a first core having a central leg and lateral legs formed on a flat portion thereof, the above-mentioned lateral legs being positioned more outwardly than the above-mentioned central leg and the above-mentioned central leg penetrating a coil formed like a plane on a board; and a second core shaped like a plate, having a penetrating hole through which the central leg of the above-mentioned first core is penetrated, positioned more inwardly than the lateral legs of the above-mentioned first core, and having a surface facing the lateral legs of the above-mentioned first core at a peripheral portion thereof, wherein both the above-mentioned cores are fixed to the above-mentioned board by bringing inner planes of both the above-mentioned cores into contact with both surfaces of the coil formed on the above-mentioned board respectively.

In accordance with a fourth aspect of the present invention, there is provided a sheet transformer wherein a coil shaped like a plane, a first core provided with a plate and legs penetrating the above-mentioned coil and a plate-shaped second core positioned on a side of the legs of the above-mentioned first core are formed by using a resin into which a magnetic powder is kneaded, inner planes of both the above-mentioned cores are in contact with the coil, and the planar coil and the cores are integrally fixed to each other and held.

Because in the sheet transformer in accordance with the first aspect of the present invention, the coil formed on the board is fixed to the cores with the coil being in contact with the cores, the sheet transformer can exhibit efficient and stable transformer characteristics.

Because in the sheet transformer in accordance with the second aspect of the present invention, the cores can be assembled to the board with the low-cost fixing member, the sheet transformer can exhibit efficient and stable transformer characteristics.

In the sheet transformer in accordance with the third aspect of the present invention, magnetic energy occurring in the coil can be easily propagated to the cores and the magnetic energy stored in the cores can be easily propagated to another coil, and hence the leakage of the energy can be reduced.

In the sheet transformer in accordance with the fourth aspect of the present invention, the cores can be formed in such a way as to be closer to the coil with the fixing means according to any one of the first and third aspects of the present invention, and the characteristics of the transformer can be further improved. Furthermore, the molding of the core is easy, and the transformer can be manufactured at a low cost.

### BRIEF DESCRIPTION OF THE FIGURES

FIG. 1 is a front view of a sheet transformer in accordance with Embodiment 1;

FIG. 2 is a side view of the sheet transformer shown in FIG. 1;

FIG. 3 is a perspective view of a fixing member in the sheet transformer in accordance with Embodiment 1;

FIG. 4 is a cross-sectional view of a central portion of the fixing member shown in FIG. 3;

FIG. 5 shows the fixing member in the sheet transformer in accordance with Embodiment 1, FIG. 5(A) is a front view of the fixing member, FIG. 5(B) is a bottom view of the fixing member, and FIG. 5(C) is a side view of the fixing member;

FIG. 6 is a perspective view of another example of the fixing member;

FIG. 7 shows the fixing member shown in FIG. 6 in further detail, FIG. 7(A) is a front view of the fixing member, FIG. 7(B) is a bottom view of the fixing member, and FIG. 7(C) is a side view of the fixing member;

FIG. 8 is a schematic front view of a sheet transformer in accordance with Embodiment 2;

FIG. 9 is a schematic exploded perspective view of the sheet transformer shown in FIG. 8;

FIG. 10 is a schematic front view showing an example of a connection between a coil and electrodes;

FIG. 11 is a schematic front view showing another example of the connection between the coil and the electrodes;

FIG. 12 is a cross-sectional view of a sheet transformer in accordance with Embodiment 3;

FIG. 13 is an exploded perspective view of the sheet transformer shown in FIG. 12;

FIG. 14 is a plane view of the sheet transformer shown in FIG. 12;

FIG. 15 is a cross-sectional view of a sheet transformer in accordance with Embodiment 4;

FIG. 16 is a cross-sectional view of a variant of the sheet transformer shown in FIG. 15;

FIG. 17 is a plane view showing a conventional planar coil; and

FIG. 18 is a plane view of a coil in accordance with Embodiment 5.

### EMBODIMENTS OF THE INVENTION

Hereafter, in order to explain this invention in greater detail, the preferred embodiments of the present invention will be described with reference to the accompanying drawings.

### Embodiment 1

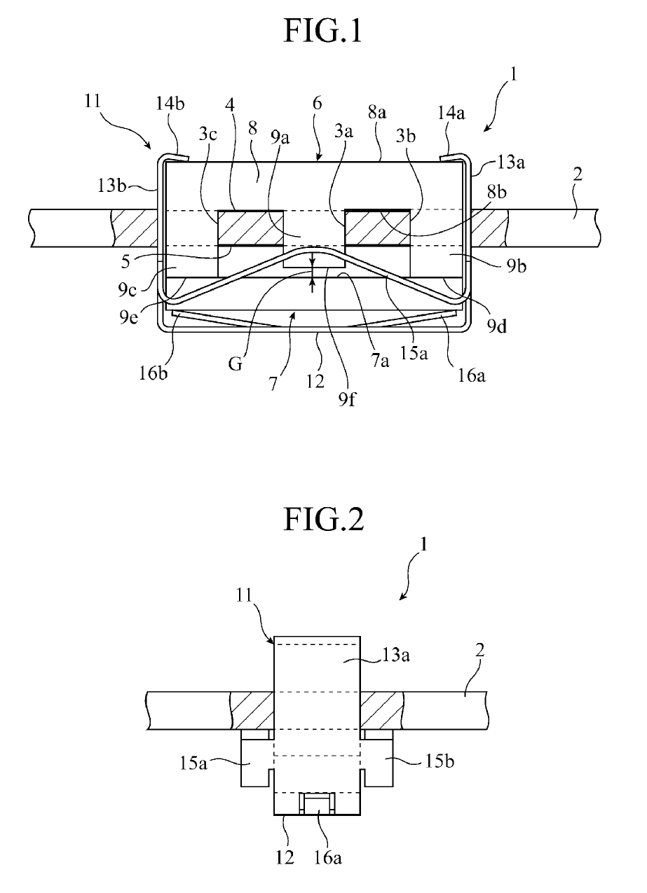

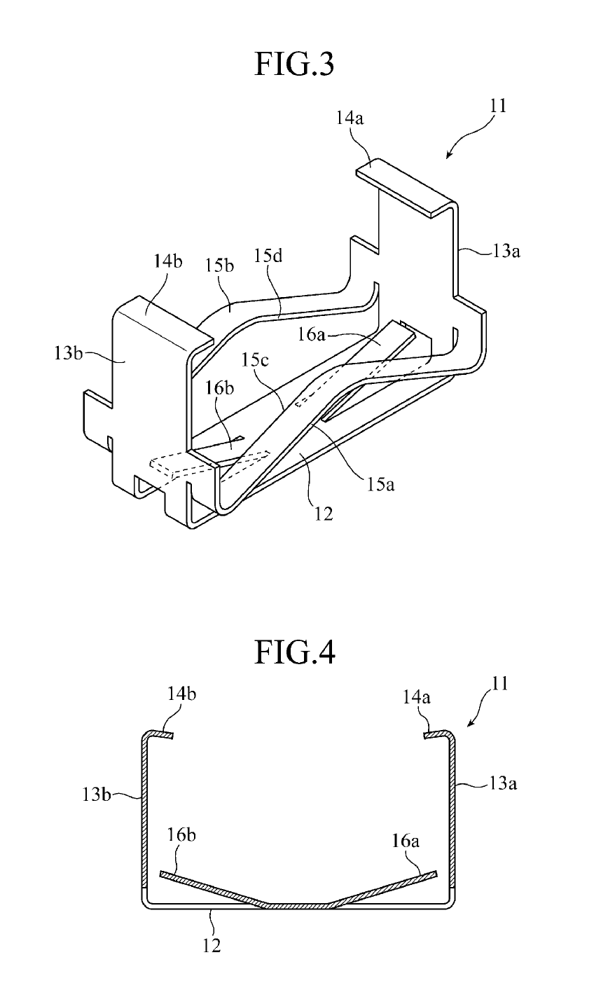

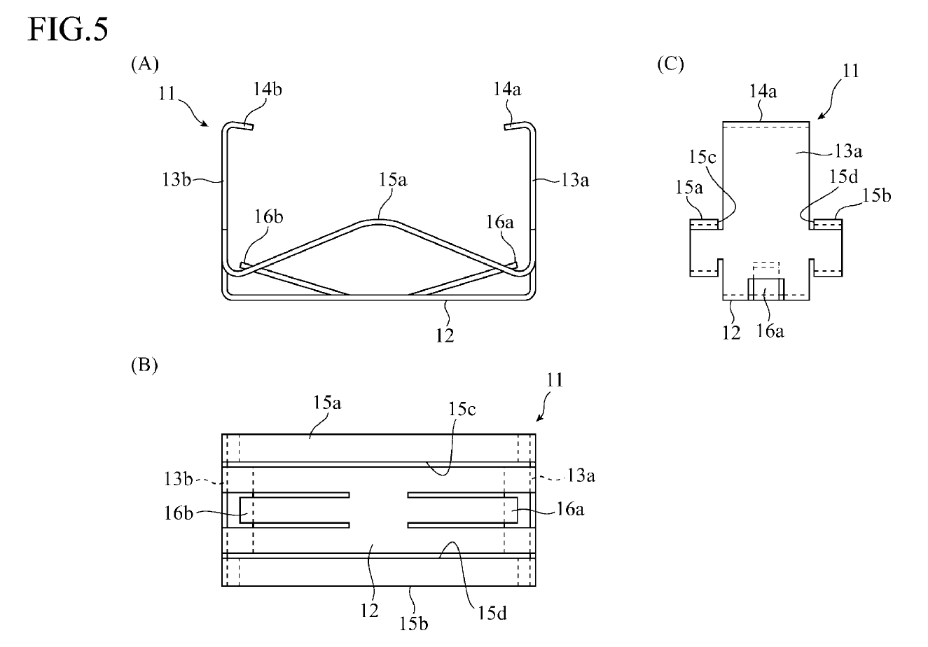

Embodiment 1 is an embodiment of first and second aspects of the present invention. FIG. 1 is an outline front view of a sheet transformer for DC/DC converter in accordance with Embodiment 1, FIG. 2 is a side view of the sheet transformer for DC/DC converter, FIG. 3 is a perspective view of a fixing member, FIG. 4 is a longitudinal cross-sectional view of the fixing member taken along a center line, and FIGS. 5(A), 5(B), and 5(C) are a front view of, a bottom view of, and a side view of the fixing member.

The sheet transformer 1 is comprised of a circuit board 2 which is a board for mounting electronic parts of electronic equipment in question as one of components thereof. The circuit board 2 is a multilayer board in which a plurality of conductors for wiring are layered. While the electronic parts which construct the circuit are mounted on this circuit board 2, a coil is formed in the circuit board. The coil consists of a primary coil formed of conducting foils (copper foils) on front and rear surfaces of the circuit board, and a secondary coil formed of a conducting foil (a copper foil) in an inner layer. A core central leg insertion hole 3a and core lateral leg insertion holes 3b and 3c on both sides of the core central leg insertion hole 3a are formed in the circuit board 2 in such a way as to penetrate the circuit board, and the above-mentioned coil is formed approximately concentrically around an axis which is a central line of the core central leg insertion hole 3a. In FIG. 1, the primary coil formed of the conducting foils 4 and 5 on the front and rear surfaces of the circuit board 2 is shown.

A core member consists of an E shaped core 6 and an I shaped core 7. The E shaped core 6 is a core having an E shaped cross section, and consists of a flat portion 8, a central leg 9a raised from a central portion of this flat portion 8, and lateral legs 9b and 9c raised from both ends of the flat portion 9. The height of the central leg 9a is slightly smaller than those of the lateral legs 9b and 9c. The I shaped core 7 is a plate-like core having an I shaped cross section. Each of the E shaped core 6 and the I shaped core 7 is formed by, for example, performing sintering and molding of a magnetic material powder such as a ferrite power.

From one side of the circuit board 2 (in a state shown in FIGS. 1 and 2, from an upper side of the circuit board), the central leg 9a of the E shaped core 6 is passed through the core central leg insertion hole 3a of the circuit board 2 and the lateral legs 9b and 9c are passed through the core lateral leg insertion holes 3b and 3c respectively, and, from the other side of the circuit board 2 (in the state shown in FIGS. 1 and 2, from a lower side of the circuit board), the I shaped core 7 is positioned in such a way that a surface 7a of the I shaped core 7 is brought into contact with end surfaces 9d and 9e of the lateral legs 9b and 9c of the E shaped core 6. A gap G is formed between an end surface 9f of the central leg 9a of the E shaped core 6, and the surface 7a of the I shaped core 7. In a case in which the transformer is a flyback one, the inductance of the transformer is adjusted by using this gap G. In this state, the E shaped core 6 and the I shaped core 7 are fixed to each other by the fixing member 11 which is attached to the circuit board 2 from the lower side of the circuit board 2, and are also fixed to the circuit board 2.

The fixing member 11 will be explained with reference to FIGS. 3, 4, and 5. Holder portions 13a and 13b are formed in such a way as to rise from both ends of a plate-shaped board portion 12. Upper ends of the holder portions 13a and 13b are bent inwardly to form them into claw portions 14a and 14b respectively. Side parts of the board portion 12 are bent upwardly into chevron shape to form them into board pressing spring portions 15a and 15b serving as a first spring portion. The gap between the board pressing spring portions 15a and 15b is set to be slightly greater than the width of the E shaped core 6. Both right and left end parts of a central portion of the board portion 12 are partially cut out from the board portion and bent upwardly from the board portion to form them into leg pressing spring portions 16a and 16b serving as a second spring portion. The fixing member 11 is made from a metallic plate, such as a stainless steel plate, or a material having elasticity, such as a resin, and the board pressing spring portions 15a and 15b and the leg pressing spring portions 16a and 16b exhibit spring elasticity.

In a state in which the E shaped core 6 and the I shaped core 7 are mounted to the circuit board 2, from the lower side of the circuit board 2, the holder portions 13a and 13b of the fixing member 11 are passed through the gaps between the core lateral leg insertion holes 3b and 3c of the circuit board 2, and the lateral legs 9b and 9c of the E shaped core 6, which are inserted into the holes, respectively, and the claw portions 14a and 14b at the upper ends of the holder portions 13a and 13b are engaged with an outer plane 8a of the flat portion 8 of the E shaped core 6. The board pressing spring portions 15a and 15b of the fixing member 11 are flexibly brought into contact with the rear face of the circuit board 2. More specifically, the E shaped core 6 is fixed to the circuit board 2 by the holder portions 13a and 13b and the board pressing spring portions 15a and 15b in such a way that the E shaped core is pressed against the circuit board. As a result, inner planes 8b of the flat portion 8 among the legs 9a, 9b and 9c of the E shaped core 6 are brought into intimate contact with the primary coil 4 formed on the front surface of the circuit board 2.

Furthermore, inner edges 15c and 15d of the board pressing spring portions 15a and 15b are positioned on both side surfaces of each of the E shaped core 6 and the I shaped core 7 respectively, so that the position of the I shaped core 7 is restricted with respect to the E shaped core 6. More specifically, in this Embodiment 1, the inner edges 15c and 15d of the board pressing spring portions 15a and 15b serve as a position restricting portion. In addition, the leg pressing spring portions 16a and 16b press both end portions of the I shaped core 7 against the end surfaces 9d and 9e of the lateral legs 9b and 9c of the E shaped core 6 respectively so as to bring the I shaped core into intimate contact with the E shaped core. On the other hand, the gap G between the end surface 9f of the central leg 9a of the E shaped core 6 and the surface 7a of the I shaped core 7 is maintained. More specifically, in this Embodiment 1, the end surface 9f of the central leg 9a serves as a gap formation portion.

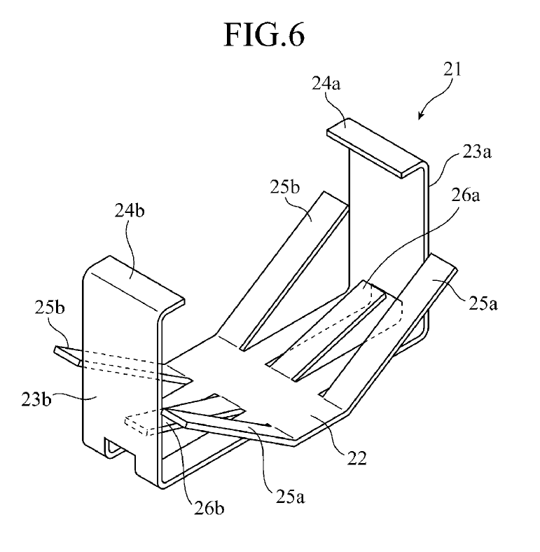

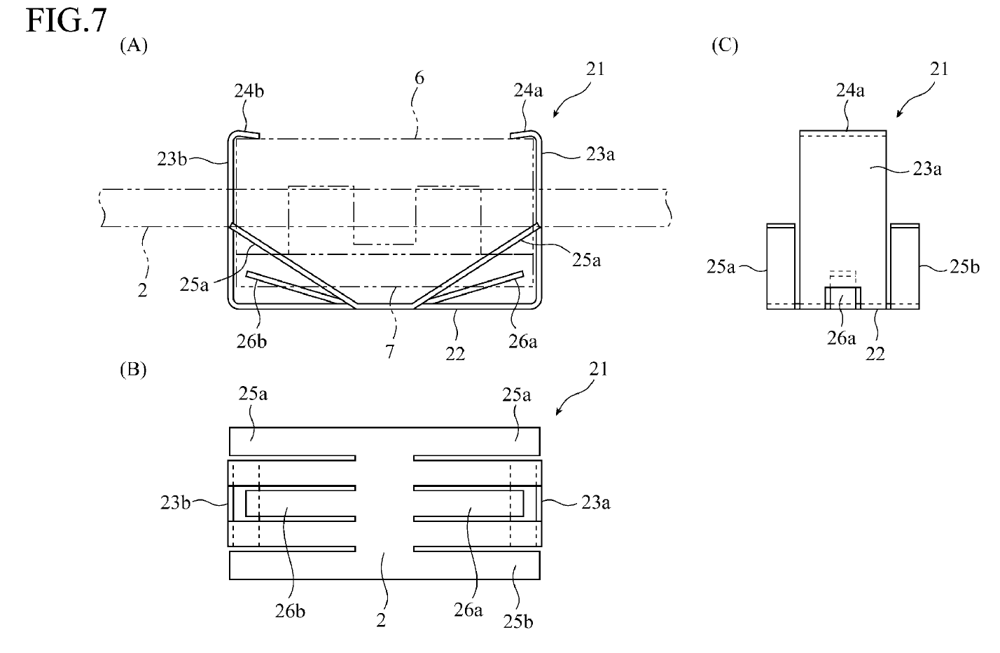

Another example of the fixing member 21 is shown in FIGS. 6 and 7. FIG. 6 is a perspective view of the fixing member 21, and FIG. 7(A) is a front view of the fixing member, FIG. 7(B) is a bottom view of the fixing member, and FIG. 7(C) is a side view of the fixing member.

Holder portions 23a and 23b are formed in such a way as to rise from both ends of a plate-shaped board portion 22. Upper ends of the holder portions 23a and 23b are bent inwardly to form them into claw portions 24a and 24b respectively. Both left and right end parts of side portions of the board portion 22 are bent upwardly to form them into board pressing spring portions 25a and 25b serving as a first spring portion. The gap between the board pressing spring portions 25a and 25b (between edges of the board pressing spring portions 25a and 25b) is set to be slightly greater than the width of the E shaped core 6. Both right and left end parts of a central portion of the board portion 22 are partially cut out from the board portion and bent upwardly from the board portion to form them into leg pressing spring portions 26a and 26b serving as a second spring portion. The fixing member 21 is made from a metallic plate, such as a stainless steel plate, or a material having elasticity, such as a resin, and the board pressing spring portions 25a and 25b and the leg pressing spring portions 26a and 26b exhibit spring elasticity.

A process of fixing the E shaped core 6 and the I shaped core 7 to the circuit board in the case of using this fixing member 21 is the same as that in the case of using the fixing member 11. In this fixing member 21, the board pressing spring portions 25a and 25b are brought into contact with the rear face of the circuit board 2 to fix the E shaped core 6 to the circuit board 2.

Even in a case in which the core member is of EE type having a gap at the center thereof (in a combination in which both the first and second cores are E shaped cores), the inner planes of the cores can be in contact with the primary coil which is a planar coil, and the sheet transformer can have good characteristics to some extent as long as the position of the gap of the planar coil does not overlap, though the space between the surface opposite to the inner planes of the cores in contact with the planar coil, and the planar coil becomes wide, and the flux of magnetic induction leaks easily. It is therefore preferable to use a core member of EI type in which the gap is biased toward one side of the core member, like in the case of this Embodiment 1.

Because in the sheet transformer 1 in accordance with this Embodiment 1, the use of the fixing member 11 brings the primary coil 4, which is formed in the circuit board 2, into contact with the E shaped core 6 so as to fix the E shaped core to the circuit board, the sheet transformer can exhibit efficient and stable transformer characteristics. Furthermore, because the E shaped core 6 and the I shaped core 7 can be fixed to the circuit board 2 only by mounting the fixing member 11 to them, the cost of the sheet transformer can be lowered and the mounting work can be simplified. Because the leg pressing spring portions 16a and 16b of the fixing member 11 press the end portions of the I shaped core 7 against the end surfaces 9d and 9e of the lateral legs 9b and 9c of the E shaped core 6 respectively to bring the I shaped core into intimate contact with the E shaped core, but do not press the central portion of the I shaped core 7, it can be ensured that the gap G required for the flyback transformer has an exact size. Furthermore, because the leg pressing spring portions do not press the central portion of the I shaped core 7, a stress can be prevented from occurring in the central portion of the I shaped core 7 and hence breakage can be prevented from occurring in the I shaped core 7. Also in the case of using the fixing member 21, the same advantages are provided.

### Embodiment 2

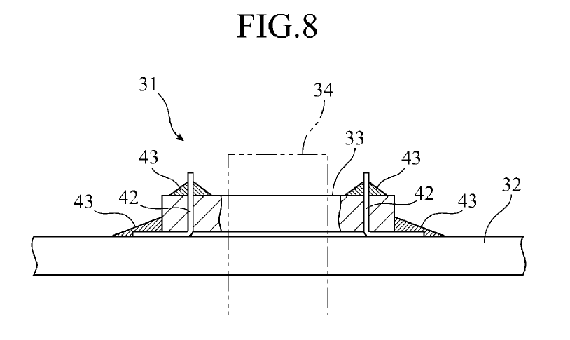

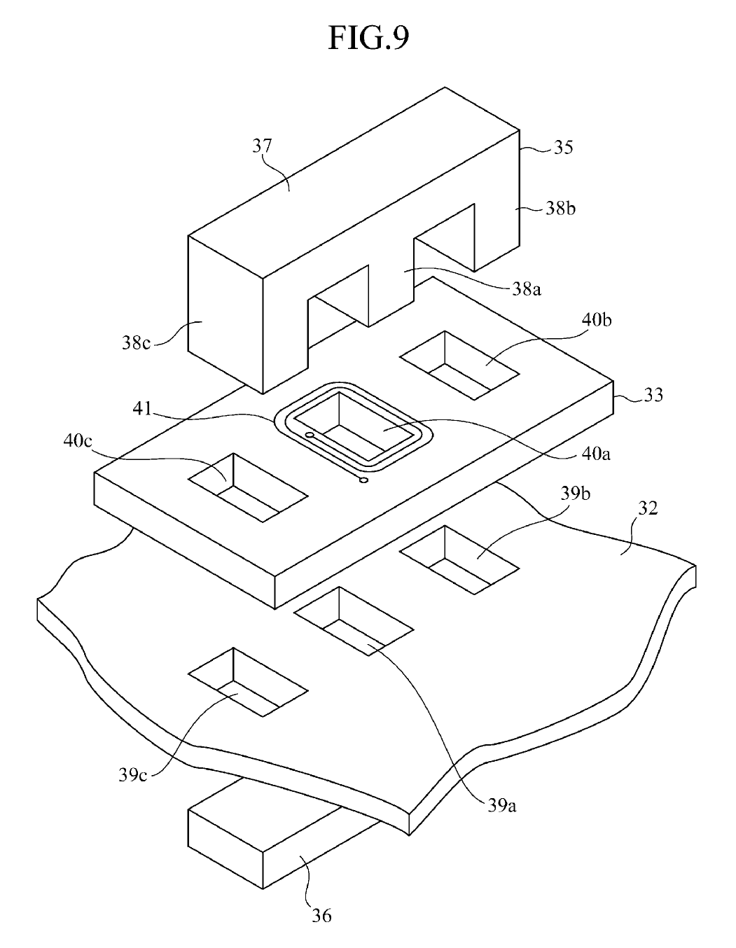

A sheet transformer in accordance with this Embodiment 2 is constructed in such a way that in any of the first and second aspects of the present invention, a board used for transformer formation (plane coil formation) is disposed separately from a board on which electronic parts are mounted, and a core member is mounted to the board used for transformer formation. FIG. 8 is a schematic front view of the sheet transformer in accordance with this Embodiment 2, and FIG. 9 is a schematic exploded perspective view of the sheet transformer.

In this sheet transformer 31, the board for coil 33 is disposed on the board for mounting electronic parts 32 which is the board on which electronic parts are mounted. A coil is formed in this board for coil 33. The core member 34 consists of an E shaped core 35 and an I shaped core 36 which is combined with the E shaped core 35. The E shaped core 35 consists of a flat portion 37, a central leg 38a raised from a central portion of this flat portion 37, and lateral legs 38b and 38c raised from both ends of the flat portion 37, like the E shaped core 6 in accordance with Embodiment 1. A central leg insertion hole 39a for making the central leg 38a of the E shaped core 35 pass therethrough and lateral leg insertion holes 39b and 39c for making the lateral legs 38b and 38c of the E shaped core 35 pass therethrough respectively are formed in the board for mounting electronic parts 32 in such a way as to be penetrated through the board. A board-for-coil central leg insertion hole 40a and board-for-coil lateral leg insertion holes 40b and 40c are formed in the board for coil 33 with the same arrangement as that of the leg insertion holes 39a, 39b, and 39c of the board for mounting electronic parts 32 in such a way as to be penetrated through the board.

The board for coil 33 is a multilayer board in which a plurality of conducting wires for coil are layered, and a primary coil is formed on both front and rear surfaces of the board for coil, and a secondary coil is formed in inner layers. In the board for coil 33, the primary coil and the secondary coil are formed approximately concentrically around an axis which is a central line of the core central leg insertion hole 40a. In FIG. 9, the primary coil 41 formed on the front surface of the board for coil 33 is shown.

In this sheet transformer 31, combining of the E shaped core 35 and the I shaped core 36 and fixation of them to the board for coil 33 are carried out by using a fixing member having the same structure as either the fixing member shown in FIGS. 3 to 5 or the fixing member shown in FIGS. 6 and 7. In this case, each of the holder parts of the fixing member is longer than that of the fixing member shown in FIGS. 3 to 5 or the fixing member shown in FIGS. 6 and 7 by a length corresponding to the thickness of the board for coil 33.

Assembly of this sheet transformer 31 is the same as that of the sheet transformer in accordance with Embodiment 1. The central leg 38a and the lateral legs 38b and 38c of the E shaped core 35 are passed through the board-for-coil central leg insertion hole 40a and the board-for-coil lateral leg insertion holes 40b and 40c of the board for coil 33, and the leg insertion holes 39a, 39b, and 39c of the board for mounting electronic parts 32, and the I shaped core 36 is then positioned with the I shaped core being in contact with end surfaces of the lateral legs 38b and 38c of the E shaped core 35. After that, from a side of the I shaped core 36, the holder portions of the fixing member are passed through the lateral leg insertion holes 39b and 39c of the board for mounting electronic parts 32 and the board-for-coil lateral leg insertion holes 40b and 40c of the board for coil 33, claw portions at ends of the holder portions are engaged with an outer surface of the E shaped core 35. More specifically, the sheet transformer 31 is constructed in such a way that the core member 34 penetrates the two boards 32 and 33. In a state in which the sheet transformer is assembled, a gap required for the flyback transformer is formed between the central leg 38a of the E shaped core 36, and a surface of the I shaped core 36.

As shown in FIG. 8, terminals 42 for soldering which are connected to the coil are formed in the board for coil 33, and these terminals 42 are soldered to electrodes (not shown) disposed on the board for mounting electronic parts 32. In FIG. 8, reference numeral 43 denotes soldered portions.

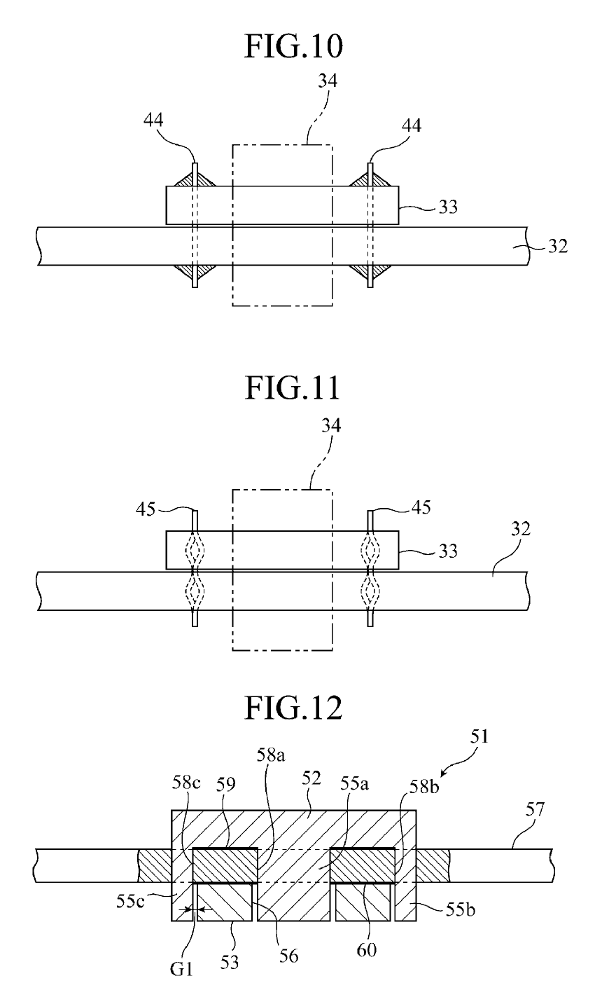

As a method of connecting the terminals connected to the coil of the board for coil 33 to the electrodes disposed on the board for mounting electronic parts 32, rod-shaped terminals 44 penetrating both electrode holes formed in the coil and electrode holes formed in the board for mounting electronic parts 32 can be disposed and can be soldered to the electrode holes, as shown in FIG. 10.

As another method of connecting the coil of the board for coil 33 to the electrodes disposed on the board for mounting electronic parts 32, both the electrode holes connected to the coil formed in the board for coil 33, and the electrode holes formed in the board for mounting electronic parts 32 can be connected to each other by press-fitting press fit terminals 45 which can penetrate both of them into both of them, as shown in FIG. 11.

In the sheet transformer 31 in accordance with this Embodiment 2, because the board for coil 33 used for forming the sheet transformer 31 is disposed as a component separate from the board for mounting electronic parts 32, each of the conducting foils in the board for coil 33 can be formed to be thicker than those formed in the board for electronic parts 32. For example, each of the conducting foils in the board for electronic parts 32 has a thickness of about 35 micrometers, whereas each of the conducting foils in the board for coil 33 has a thickness of about 70 micrometers. By thickening each of the conducting foils which form the coil, its cross-sectional area becomes large and the resistance of the coil can be lowered. Although the cost of the sheet transformer inevitably increases with increase in the thickness of each of the conducting foils, the increase in the thickness of each of the conducting foils has a small influence on the cost because the board for coil 33 which forms the coil is small as compared with the board for mounting electronic parts 32 on which electronic parts are mounted. Therefore, the sheet transformer can be constructed to have better characteristics at a relatively low cost.

The sheet transformer 31 in accordance with this Embodiment 2 provides not only the same advantages as those provided by the sheet transformer 1 in accordance with Embodiment 1, but also the following advantages.

Although it is desirable to use a multilayer board having four or more layers in order to form the coil as a transformer, a board having two layers on the front and rear surfaces thereof on which electronic parts are mounted is cheap and is easy to use. Like in the case of the sheet transformer 31 in accordance with Embodiment 2, in a case in which the substrate for coil 33 which constructs the sheet transformer 31 is disposed separately from the board for mounting electronic parts 32 on which electronic parts are mounted, the narrow (small) coil member can be formed of multiple layers in the substrate for coil 33 and the wide (large) board for mounting electronic parts 32 can be formed of two layers. As a result, the sheet transformer which is thus integrally formed can be implemented at a low cost, and therefore a DC/DC converter can be manufactured at a low cost and can be downsized.

In this Embodiment 2, as shown in FIGS. 8 and 10, the coil of the board for coil 33 can be connected to the electrodes of the board for mounting electronic parts 32 by means of soldering. Therefore, the board for coil can be mounted to the board for mounting electronic parts by using reflow solder without being subjected to any special process, and the mounting process is simplified. As an alternative, as shown in FIG. 11, the press fit terminals 45 can be used for the connection between the coil of the substrate for coil 33 and the electrodes of the board for mounting electronic parts 32. Also in this case, the sheet transformer can be assembled without being subjected to any soldering process, and the assembling process is simplified and the productivity is also improved.

### Embodiment 3

This Embodiment 3 is an embodiment of a sheet transformer in accordance with a third aspect of the present invention.

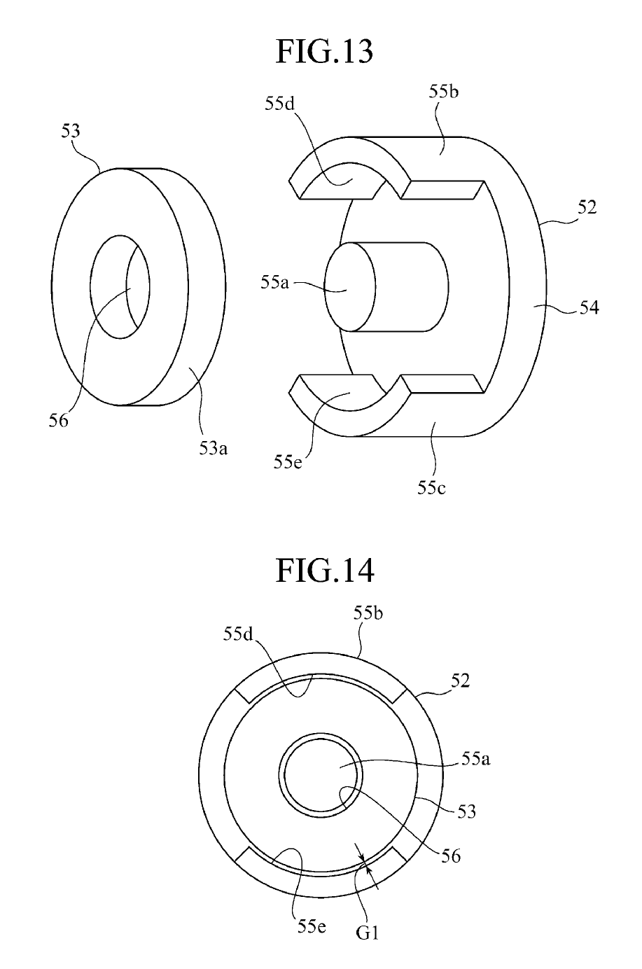

FIG. 12 is a schematic cross-sectional view of the sheet transformer in accordance with Embodiment 3, FIG. 13 is an exploded perspective view of the sheet transformer, and FIG. 14 is a plane view of the sheet transformer.

In this sheet transformer 51, a core member consists of an outer core 52 as a first core, and an inner core 53 as a second core. The outer core 52 has an central leg 55a formed in a central part of a disc-shaped flat portion 54 and arc-shaped lateral legs 55b and 55c disposed in edges of the flat portion 54, and has a cross-sectional shape of the letter E. The gap between the lateral legs 55b and 55c is an entrance/exit of a coil formed in a board. The inner core 53 has a substantially circle shape, and a penetrating hole 56 is formed in a central part of the inner core.

In the board for mounting electronic parts 57, a circular central leg penetrating hole 58a for making the central leg 55a penetrate therethrough, and arc-shaped lateral leg penetrating holes 58b and 58c for making the lateral legs 55b and 55c penetrate therethrough are formed. The planar coil is formed in the board for mounting electronic parts 57 around the central leg penetrating hole 58a. In the coil, for example, primary coils 59 and 60 are formed on the front and rear surfaces of the board for mounting electronic parts 57, and a secondary coil (not shown) having two or more layers is formed in inner layers of the board for mounting electronic parts 57.

The outer core 52 is mounted to the board for mounting electronic parts 57 by passing the central leg 55a through the central leg penetrating hole 58a of the board for mounting electronic parts 57, and also passing the lateral legs 55b and 55c through the lateral leg penetrating holes 58b and 58c of the board for mounting electronic parts 57 from the front surface of the board for mounting electronic parts 57. The inner core 53 is positioned inside the lateral legs 55b and 55c of the outer core 52 by passing the central leg 55a of the outer core 52 through the penetrating hole 56 from a lower side of the board for mounting electronic parts 57. An inner plane 54a between the central leg 55a of the outer core 52 and the lateral legs 55b and 55c of the outer core 52 is brought into intimate contact with the primary coil 59 formed to the front surface of the board for mounting electronic parts 57. The inner core 53 is brought into intimate contact with the primary coil 60 formed on the rear face of the board for mounting electronic parts 57. A gap G1 extending in a circumferential direction is formed between a peripheral surface 53a of the inner core 53, and inner surfaces 55d and 55e of the lateral legs 55b and 55c of the outer core 52. A connection between the primary coils 59 and 60 of the board for mounting electronic parts 57 and electrodes disposed on the board for mounting electronic parts 57 is made via the space between the lateral legs 55b and 55c of the outer core 52.

Although the inner core 53 can be circular, the inner core 53 can be alternatively formed into a non-circle shape, e.g. an ellipse. In a case in which the inner core 53 formed into an ellipse, the gap between the peripheral surface 53a of the inner core 53 and the inner surfaces 55d and 55e of the lateral legs 55b and 55c of the outer core 53 can be varied by rotating the inner core 53, so that the characteristics of the transformer can be adjusted.

Because in the sheet transformer 51 in accordance with this Embodiment 3, the outer core 52 and the inner core 53 are brought into intimate contact with the primary coils 59 and 60 formed on both the front and rear surfaces of the board for mounting electronic parts 57 respectively, the characteristics of the transformer can be improved. More specifically, magnetic energy occurring in the primary coils can be easily propagated to the cores 52 and 53 and the magnetic energy stored in the cores 52 and 53 can be easily propagated to the secondary coil, and hence the leakage of the energy can be reduced. Furthermore, in a case in which the inner core 53 formed into a non-circle shape, the length of the gap G1 can be varied by rotating the inner core 53, and hence the inductance of the transformer can be adjusted to a required value. As a result, the transformer can be constructed to have little variation in its characteristics.

### Embodiment 4

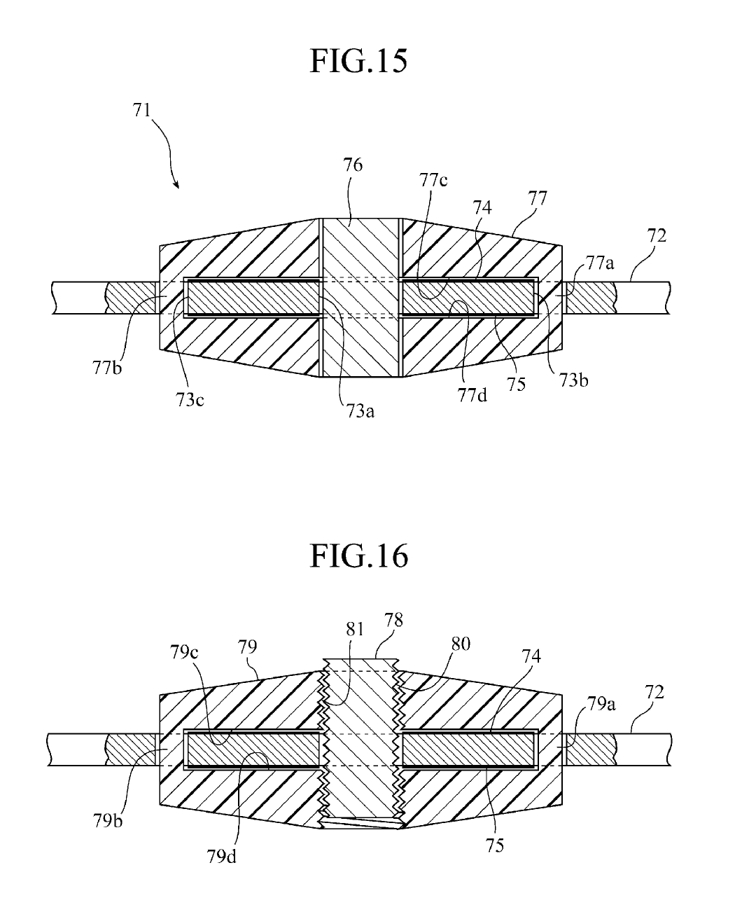

Embodiment 4 is an embodiment of a sheet transformer in accordance with a third aspect of the present invention. FIG. 15 shows a cross section of the sheet transformer 71 in accordance with Embodiment 4.

A central leg penetrating hole 73a which a central leg of a core member penetrates, and lateral leg penetrating holes 73b and 73c which lateral legs of the core member penetrate respectively are formed in a board 72. Planar coils (conducting foils) are formed on the board 72 around the central leg penetrating hole 73a. In FIG. 15, coils 74 and 75 formed on both front and rear surfaces of the board 72 are shown. A cylindrical ferrite core 76 which serves as the central leg which is a part of a first core penetrates the central leg penetrating hole 73a of the board 72. By pouring a resin into which a magnetic powder is kneaded into a mold with the board 72 being sandwiched by portions of the mold, a magnetic powder kneaded resin core 77 which constructs the first core and a second core is insert-molded. A portion facing the board 72 in the magnetic powder kneaded resin core 77 corresponds to the flat portion of the above-mentioned core, and portions 77a and 77b integrally formed with the flat portion, and extending from edges of the flat portion and penetrating the lateral leg penetrating holes 73b and 73c correspond to the lateral legs. The magnetic powder kneaded resin core 77 can be formed into, for example, a circular shape when seen from a plane. A connection between the coils 74 and 75 and electrodes disposed on the board 72 is made via the space between the portions 77a and 77b corresponding to the lateral legs. Inner planes 77c and 77d of the magnetic powder kneaded resin core 77 face the coils 74 and 75 formed on the board 72 respectively, and are brought into intimate contact with the coils 74 and 75 respectively.

Because the magnetic powder contained in the magnetic powder kneaded resin core 77 is divided into small pieces by the resin into which the magnetic powder is kneaded from a microscopic viewpoint, each of the pieces can be assumed to be a small gap and a characteristic similar to that of the gap of a magnetic substance (ferrite) core can be acquired.

Although all the portions corresponding to the first and second cores can be formed of the magnetic powder kneaded resin, the central leg portion which cannot have a large cross-sectional area consists of the ferrite core 76 made from ferrite which is a solid magnetic material because the magnetic powder kneaded resin has low magnetic permeability. More specifically, the magnetic permeability of the magnetic powder kneaded resin is low (its magnetic resistance is large), and the cross-sectional areas of the flat portion and the legs have to be increased in order to provide good transformer characteristics only by using the magnetic powder kneaded resin. While an increase of the cross-sectional area can be achieved with relative ease in either of the lateral legs and the flat portion, an increase in the cross-sectional area of the central leg in which the flux of magnetic induction concentrates causes an enlargement of the coils and characteristic degradation resulting from an electric resistance increase caused by the enlargement of the coils. In contrast, in the case in which the ferrite core 76 is used only as the central leg portion, the magnetic resistance can be reduced with the small cross-sectional area, and good transformer characteristics can be acquired with the small coils.

In Embodiment 4 shown in FIG. 15, the ferrite core 76 and the magnetic powder kneaded resin core 77 are integrally formed via a straight cylinder. As an alternative, as shown in FIG. 16, screw-shaped projecting and recessed portions 80 and 81 can be formed in an outer surface of a ferrite core 7 and in an inner surface of a magnetic powder kneaded resin core 79 respectively, and can be engaged with each other, In this case, the ferrite core 78 can be moved in an axial direction with respect to the magnetic powder kneaded resin core 79, and can be stopped at an arbitrary depth. More specifically, the ferrite core 78 is shaped like a bolt, and the inner surface of the magnetic powder kneading resin core 79 is shaped like a nut.

By rotating the ferrite core 78 corresponding to the central leg to move the ferrite core forwardly or backwardly, the area of a portion of the ferrite core 78 facing the magnetic powder kneaded resin core 79 can be varied to an arbitrary size. Furthermore, the ferrite core can be easily fixed to the position after the adjustment. Therefore, the inductance which is the key point for providing the characteristics of the transformer can be adjusted easily (the adjustment of the above-mentioned gap is aimed at the adjustment of the inductance), and the characteristics of the transformer acquired after the adjustment can be maintained with stability.

Because in the sheet transformer in accordance with Embodiment 4, the portions 77a, 77b, 79a and 79a of the magnetic powder kneaded resin cores 77 and 79b are brought into intimate contact with the coils formed on the board 72, the cores can be formed in such a way as to be further close to the coils, and the characteristics of the transformer can be improved. Furthermore, because the molding of the magnetic powder kneaded resin core is easy, the transformer can be manufactured at a low cost. In addition, in the case in which the central leg is the ferrite core 76 or 78, the cross-sectional area of the central core can be reduced, and hence the transformer can be downsized. As shown in FIG. 16, in the case in which the ferrite core 78 is formed in such a way as to be movable with respect to the magnetic powder kneaded resin core 79, variations in the inductance resulting from the characteristics and a mixed amount (density) of the magnetic material (the magnetic powder) kneaded to the resin can be corrected (adjusted) for the transformer on an individual basis.

### Embodiment 5

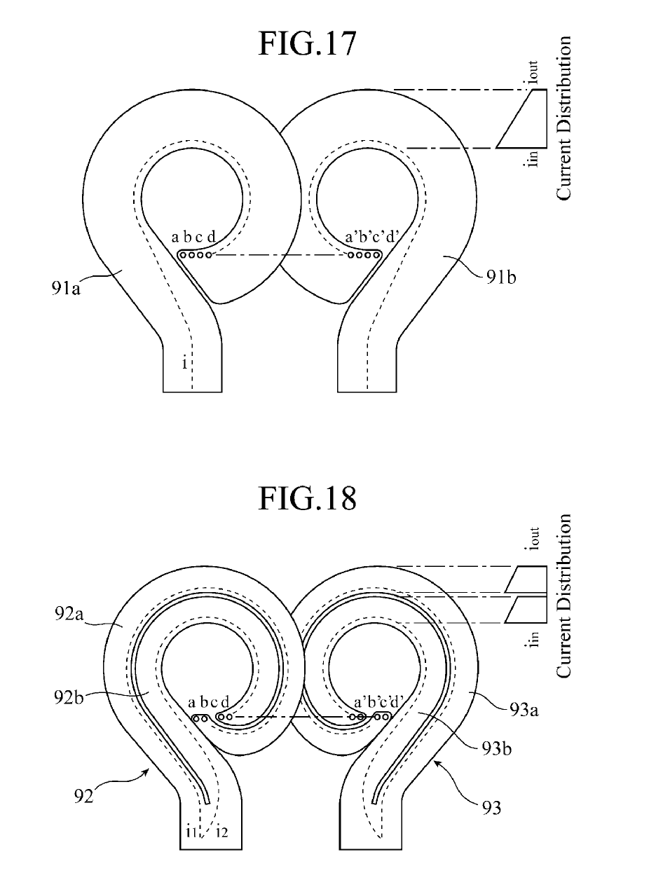

Embodiment 5 relates to coils formed on a board, and can be applied any one of all the above-mentioned embodiments. Conventional spiral coils are shown in FIG. 17, and spiral coils in accordance with this Embodiment 5 are shown in FIG. 18.

As shown in FIG. 17, because a current flowing through each of the wide planar coils 91a and 91b flows through a path having the shortest distance in which the electric resistance is substantially small, the current concentrates in the shortest-distance path and the current density of this portion becomes high. In FIG. 17, i shows the current, and in current distribution, iin shows a current value flowing through an inner portion of each of the coils 91a and 91b, and iout shows a current value flowing through an outer portion of each of the coils 91a and 91b. Therefore, a conductor in which the current is flowing substantially is thinner than the apparent conductor, and a flux of magnetic induction occurs intensively along the substantial thin current path. Therefore, because no current flows through the periphery of the conductor, the conductor does not work as a coil. Worse yet, there is a possibility that the flux of magnetic induction occurring in the thin current path and then propagating to the core leaks from the core (the magnetic energy leaks), and the characteristics of the transformer degrades.

Therefore, as shown in FIG. 18, a plurality of planar coils 92 and 93 each formed of a conducting foil (a plurality of spiral conducting foils) are divided into divided coils (divided spiral conducting foils) 92a, 92b, 93a, and 93b. The divided coils 92a, 92b, 93a, and 93b are connected in series, via conductors penetrating the board, to the corresponding divided coils to form single coils respectively, and the plurality of single coils each having divided coils connected in series to each other are wound in parallel as a set coil. Furthermore, when connecting in series a plurality of divided coils which are respectively arranged at a plurality of positions formed in each of a plurality of layers, each of the above-mentioned plurality of single coils connected to each other in parallel is formed into a single coil by selectively connecting divided coils at different positions in the plurality of layers. The number of parts into which each coil is divided is not limited to two, and division of each coil into three or more parts according to the coil width is more effective.

Because the use of the coils each of which is divided into parts in accordance with this Embodiment 5 makes it possible for the same amount of current to flow through each of the paths, the current can be prevented from concentrating on a specific thin path. Therefore, a substantially uniform magnetic field occurs in the core member, the magnetic energy is easily propagated to the core member, and the leakage of the flux of magnetic induction which occurs in the coils and is propagated to the core member decreases. As a result, the characteristics of the transformer are improved.

### INDUSTRIAL APPLICABILITY

Because the sheet transformer for DC/DC converter in accordance with the present invention is constructed in such a way that the coils and the core member formed in the board are fixed to each other with them being in contact with each other, the sheet transformer for DC/DC converter exhibits high-efficient and stable characteristics. Therefore, the sheet transformer for DC/DC converter in accordance with the present invention is suitable for use as a sheet transformer for DC/DC converter which uses conducting foils (copper foils) formed in a printed circuit board as coils, and so on.

1. A sheet transformer including a coil formed like a plane on a board for electronic parts on which electronic parts are mounted, a first core provided with a plurality of legs on a flat portion thereof, the plurality of legs including legs penetrating said coil, and a plate-shaped second core positioned on ends of legs of said first core, a gap being formed in a part of a core member which is a combination of said first core and said second core, wherein an inner plane portion of said first core is in contact with said planar coil, and said first and second cores are fixed and held with respect to said coil in such a way that said gap and said coil are not positioned in one plane.

2. A sheet transformer including a coil formed like a plane on a board for electronic parts, a first core provided with a plurality of legs on a flat portion thereof, and a gap formation portion on a central one of said plurality of legs penetrating said coil, a plate shaped second core positioned on ends of legs of said first core, said first core and said second core being assembled into an integral piece and a gap being formed between said central leg and said second core, and a fixing member for fixing said first and second cores with respect to said coil, wherein
said fixing member includes:
holder portions having claw portions for holding lateral legs of said first core from a side of said second core respectively;
a first spring portion extending from a side of said second core toward said board for electronic parts, for bringing inner plane portions of said legs of said first core into contact with said coil;
a second spring portion for pressing positions of said second core which are opposite to the lateral legs of said first core; and
a positioning portion for fixing said second core at an arbitrary position with respect to said first core.

3. The sheet transformer according to claim 1, wherein said coil is formed on a board for coil which is disposed separately from said board for electronic parts, and said first core and said second core are assembled in and on said board for electronic parts and said board for coil.

4. The sheet transformer according to claim 2, wherein said coil is formed on a board for coil which is disposed separately from said board for electronic parts, and said first core and said second core are assembled in and on said board for electronic parts and said board for coil.

5. The sheet transformer according to claim 3, wherein said board for coil has a terminal for soldering which is connected to said coil at an end thereof, and an electrode disposed on said board for electronic parts is connected to said terminal by soldering said terminal to said electrode.

6. The sheet transformer according to claim 4, wherein said board for coil has a terminal for soldering which is connected to said coil at an end thereof, and an electrode disposed on said board for electronic parts is connected to said terminal by soldering said terminal to said electrode.

7. The sheet transformer according to claim 3, wherein said sheet transformer has a rod-shaped terminal penetrating both an electrode hole formed in said board for coil and connected to said coil, and an electrode hole formed in said board for electronic parts, and electrodes of both said boards are connected to each other by soldering said rod-shaped terminal to them.

8. The sheet transformer according to claim 4, wherein said sheet transformer has a rod-shaped terminal penetrating both an electrode hole formed in said board for coil and connected to said coil, and an electrode hole formed in said board for electronic parts, and electrodes of both said boards are connected to each other by soldering said rod-shaped terminal to them.

9. The sheet transformer according to claim 3, wherein electrodes of both said board for coil and said board for electronic parts are connected to each other by using a press fit terminal penetrating both an electrode hole connected to said coil on said board for coil and an electrode hole of said board for electronic parts.

10. The sheet transformer according to claim 4, wherein electrodes of both said board for coil and said board for electronic parts are connected to each other by using a press fit terminal penetrating both an electrode hole connected to said coil on said board for coil and an electrode hole of said board for electronic parts.

11. The sheet transformer according to claim 3, wherein a conducting foil forming said coil on said board for coil is thicker than a conducting foil in said board for electronic parts.

12. The sheet transformer according to claim 4, wherein a conducting foil forming said coil on said board for coil is thicker than a conducting foil in said board for electronic parts.

13. A sheet transformer comprising:
a first core having a central leg and lateral legs formed on a flat portion thereof, said lateral legs being positioned more outwardly than said central leg and said central leg penetrating a coil formed like a plane on a board; and
a second core shaped like a plate, having a penetrating hole through which the central leg of said first core is penetrated, positioned more inwardly than the lateral legs of said first core, and having a surface facing the lateral legs of said first core at a peripheral portion thereof,
wherein both said cores are fixed to said board by bringing inner planes of both said cores into contact with both surfaces of the coil formed on said board respectively.

14. The sheet transformer according to claim 13, wherein the peripheral portion of said second core has a non-circle shape.

15. A sheet transformer wherein a coil shaped like a plane, a first core provided with a plate and legs penetrating said coil and a plate-shaped second core positioned on a side of the legs of said first core are formed by using a resin into which a magnetic powder is kneaded, inner planes of both said cores are in contact with the coil, and the planar coil and the cores are integrally fixed to each other and held.

16. The sheet transformer according to claim 15, wherein the cores are integrally formed by using a solid magnetic material to form a central one of the legs penetrating a board, and by using the resin into which the magnetic powder is kneaded to form plane portions sandwiching said board and lateral ones of the legs.

17. The sheet transformer according to claim 16, wherein projections and depressions for locking a core portion having the central leg at an arbitrary position are formed in both an outer surface of the core portion having the central leg penetrating said board and formed of the solid magnetic material and an inner surface of a central leg insertion hole of a surrounding core portion into which the magnetic powder is kneaded.

18. The sheet transformer according to claim 1, wherein in a structure in which the coil is formed by connecting a plurality of spiral conducting foil layers formed on said board in series by using a conductor penetrating said board, each of said plurality of spiral conducting foil layers is divided into a plurality of spiral conducting foil divided portions, each of said plurality of spiral conducting foil divided portions is connected in series by using the conductor penetrating said board in such a way that each of said plurality of spiral conducting foil divided portions forms one coil, a plurality of coils in each of which one of said plurality of spiral conducting foil divided portions is connected in series are connected to one another in parallel to form a coil set, and, when connecting in series a plurality of conducting foil divided portions which are respectively arranged at a plurality of positions formed in each of said plurality of layers, each of said plurality of coils connected to one another in parallel is formed into a single coil by selectively connecting conducting foil divided portions at different positions in each of said plurality of layers.

19. The sheet transformer according to claim 2, wherein in a structure in which the coil is formed by connecting a plurality of spiral conducting foil layers formed on said board in series by using a conductor penetrating said board, each of said plurality of spiral conducting foil layers is divided into a plurality of spiral conducting foil divided portions, each of said plurality of spiral conducting foil divided portions is connected in series by using the conductor penetrating said hoard in such a way that each of said plurality of spiral conducting foil divided portions forms one coil, a plurality of coils in each of which one of said plurality of spiral conducting foil divided portions is connected in series are connected to one another in parallel to form a coil set, and, when connecting in series a plurality of conducting foil divided portions which are respectively arranged at a plurality of positions formed in each of said plurality of layers, each of said plurality of coils connected to one another in parallel is formed into a single coil by selectively connecting conducting foil divided portions at different positions in each of said plurality of layers.

20. The sheet transformer according to claim 13, wherein in a structure in which the coil is formed by connecting a plurality of spiral conducting foil layers formed on said board in series by using a conductor penetrating said board, each of said plurality of spiral conducting foil layers is divided into a plurality of spiral conducting foil divided portions, each of said plurality of spiral conducting foil divided portions is connected in series by using the conductor penetrating said board in such a way that each of said plurality of spiral conducting foil divided portions forms one coil, a plurality of coils in each of which one of said plurality of spiral conducting foil divided portions is connected in series are connected to one another in parallel to form a coil set, and, when connecting in series a plurality of conducting foil divided portions which are respectively arranged at a plurality of positions formed in each of said plurality of layers, each of said plurality of coils connected to one another in parallel is formed into a single coil by selectively connecting conducting foil divided portions at different positions in each of said plurality of layers.

21. The sheet transformer according to claim 15, wherein in a structure in which the coil is formed by connecting a plurality of spiral conducting foil layers formed on said hoard in series by using a conductor penetrating said board, each of said plurality of spiral conducting foil layers is divided into a plurality of spiral conducting foil divided portions, each of said plurality of spiral conducting foil divided portions is connected in series by using the conductor penetrating said board in such a way that each of said plurality of spiral conducting foil divided portions forms one coil, a plurality of coils in each of which one of said plurality of spiral conducting foil divided portions is connected in series are connected to one another in parallel to form a coil set, and, when connecting in series a plurality of conducting foil divided portions which are respectively arranged at a plurality of positions formed in each of said plurality of layers, each of said plurality of coils connected to one another in parallel is formed into a single coil by selectively connecting conducting foil divided portions at different positions in each of said plurality of layers.
